(19) United States
(12) Patent Application Publication
(10) Pub. No.: US 2010/0255724 A1
(43) Pub. Date: Oct. 7, 2010

(54) LOCKING CLIP FOR AN ELECTRICAL CONNECTOR ASSEMBLY

(75) Inventors: David Cours, Harrisburg, PA (US); Scott Hilt, York, PA (US); Robert Scott Good, Camp Hill, PA (US); Stephen Daniel Gherardini, Harrisburg, PA (US); Paul D. Roman, JR., Mechanicsburg, PA (US)

Correspondence Address: TYCO TECHNOLOGY RESOURCES, 4550 NEW LINDEN HILL ROAD, SUITE 140, WILMINGTON, DE, 19808-2952, US

(73) Assignee: Tyco Electronics Corporation, Berwyn, PA (US)

(21) Appl. No.: 12/418,099

(22) Filed: Apr. 3, 2009

(51) Int. Cl. H01R 13/40; A44B 99/00

(52) U.S. Cl. 439/595; 24/570

(57) ABSTRACT

An electrical connector assembly is disclosed that includes a receptacle connector, a plug connector and a locking clip. The locking clip securely surrounds the mated plug connector and receptacle connector to prevent the plug connector and the receptacle connector from being unmated without a tool.

### FIELD OF THE INVENTION

The present invention relates to locking clips. More specifically, the present invention relates to a locking clip for an electrical connector assembly that prevents the electrical connector assembly from being unmated without a tool.

### BACKGROUND OF THE INVENTION

Connector assemblies typically include a plug connector having a plug housing containing pin contacts mated to a receptacle connector having a receptacle housing containing socket contacts. The plug housing and the receptacle housing are physically mated, which physically and electrically connects the pin and socket contacts to form an electrical connection.

Connector assemblies may be subject to tampering or access by individuals without an adequate understanding of electrical connectors. Most connector assemblies can be unmated without the use of any special skill or tool. To address this, certain industries have promulgated specific requirements for electrical connectors. For instance, under some government codes and regulations, certain electrical connections require a tool in order to unmate any connector assembly carrying an electrical current.

To comply with requirements such as these, electrical connectors may be modified to require a tool for unmating. The modification of existing electrical connectors or the design of electrical connectors has been expensive and required complicated modifications or additions to the connector assembly.

Therefore, there is an unmet need to provide a manner of complying with requirements to use a tool for the unmating of electrical connectors that does not require expensive and complex modifications or additional modifications to existing electrical connectors.

### SUMMARY OF THE INVENTION

In one embodiment of the disclosure, an electrical connector assembly is disclosed that includes a plug connector, a receptacle connector configured to releasably mate with the plug connector, and a locking clip configured to be assembled and securely closed around the plug connector and receptacle connector when mated. The receptacle connector has an engagement feature configured to releasably engage the plug connector, and the locking clip prevents the engagement feature from being accessed without the locking clip being first removed by a tool.

In another embodiment of the disclosure, a method of locking an electrical connector assembly is disclosed that includes providing a mated plug connector and receptacle connector, the receptacle connector having an engagement feature configured to releasably engage the plug connector, and having a locking clip securely closed around the mated plug connector and receptacle connector to prevent access to the engagement feature, and opening the locking clip with a tool to provide access to the engagement feature, and unmating the plug connector and the receptacle connector.

Further aspects of the method and system are disclosed herein. The features as discussed above, as well as other features and advantages of the present invention will be appreciated and understood by those skilled in the art from the following detailed description and drawings.

### BRIEF DESCRIPTION OF THE DRAWINGS

FIG. 1 illustrates a perspective view of an exemplary electrical connector assembly according to the invention.

FIG. 2 illustrates a perspective view of the electrical connector assembly of FIG. 1 unassembled and unmated.

FIG. 3 illustrates a perspective view of an exemplary locking clip according to the invention.

FIG. 3A illustrates a perspective view of the locking clip of FIG. 3 open.

FIG. 4 illustrates a perspective view of the electrical connector assembly of FIG. 1 with the locking clip open.

Wherever possible, the same reference numbers will be used throughout the drawings to refer to the same or like parts.

### DETAILED DESCRIPTION OF THE INVENTION

The present invention now will be described more fully hereinafter with reference to the accompanying drawings, in which a preferred embodiment of the invention is shown. This invention may, however, be embodied in many different forms and should not be construed as limited to the embodiments set forth herein; rather, these embodiments are provided so that this disclosure will be thorough and complete and will fully convey the scope of the invention to those skilled in the art.

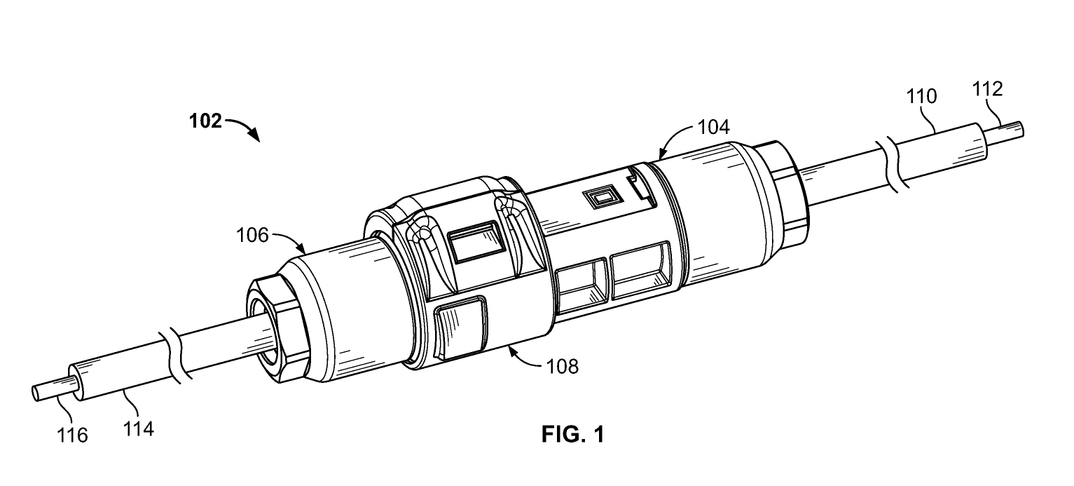

FIG. 1 illustrates an exemplary embodiment of an electrical connector assembly 102 according to the invention. The electrical connector assembly 102 includes a plug connector 104, a receptacle connector 106, and an electrical connector locking clip (locking clip) 108. In FIG. 1, the plug connector 104 and the receptacle connector 106 are mated, and the locking clip 108 is assembled around the mated plug connector 104 and receptacle connector 106 in a closed position. In this exemplary embodiment, the plug connector 104 and the receptacle connector 106 are circular connectors i.e. have a generally circular cross section, and the locking clip 108 has a corresponding generally circular cross section geometry when assembled in the closed position. In another embodiment, the plug connector 104 and the receptacle connector 106 may have a square, rectangular or other cross section geometries, with the locking clip 108 having a corresponding cross section.

As shown in FIG. 1, the plug connector 104 receives a plug cable 110 having at least one plug conductor 112 contained therein. The at least one plug conductor 112 is terminated to at least one plug contact (not shown) disposed within the plug connector 104. In this exemplary embodiment, the at least one plug contact is a pin contact. In another embodiment, the at least one plug contact may be a blade, socket, spring or other electrical contact.

As further shown in FIG. 1, the receptacle connector 106 receives a receptacle cable 114 having at least one receptacle conductor 116 contained therein. The at least one receptacle conductor 116 is terminated to at least one receptacle contact (not shown) disposed within the receptacle connector 106. In this exemplary embodiment, the at least one receptacle contact 117 is a socket contact. In another embodiment, the at least one receptacle contact 117 is a spring, pin, blade or other electrical contact correspondingly mateable with the plug contact of the plug connector 104.

The locking clip 108 is configured to be releasably assembled and securely closed around the exterior of the mated plug connector 104 and the receptacle connector 106 to prevent the plug connector 104 and receptacle connector from being unmated as shown in FIG. 1. The locking clip 108 is also configured to be opened with an appropriate tool (not shown), thereby preventing the plug connector 104 from being unmated from the receptacle connector 106 inadvertently or by personnel without the appropriate tool.

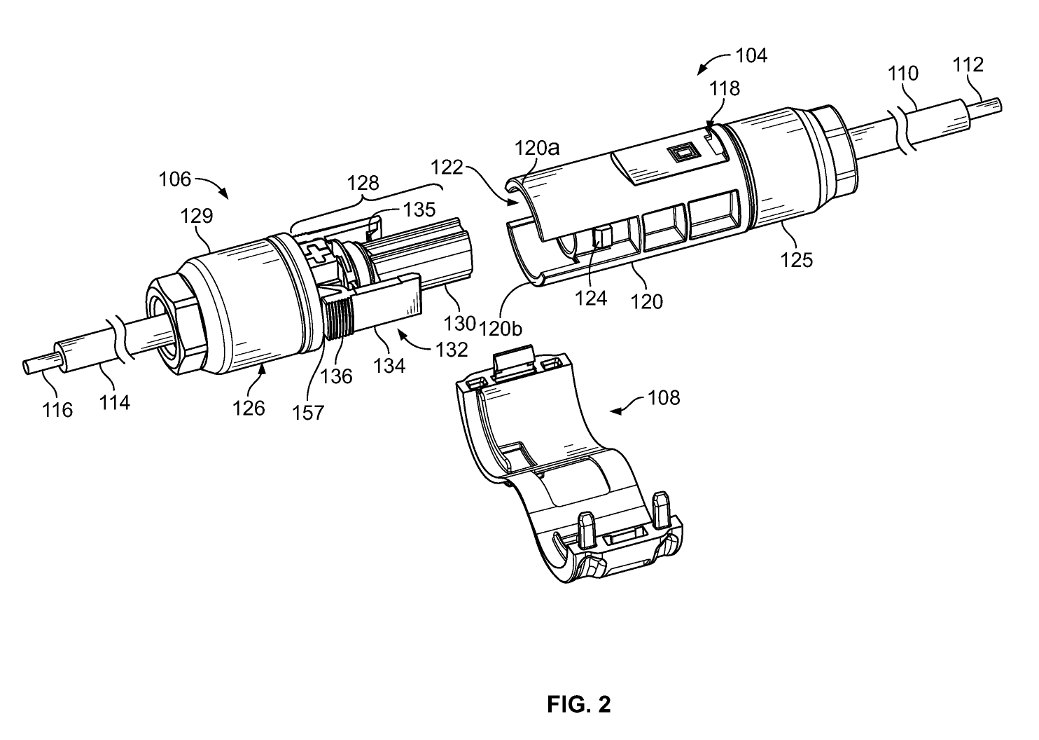

FIG. 2 shows the electrical connector assembly 102 of FIG. 1 with the plug connector 104 and receptacle connector 106 unmated, and further having the locking clip 108 opened and unassembled therefrom. As shown in FIG. 2, the plug connector 104 includes a plug housing 118 including a plug housing engaging portion 120 and a rear portion 125. The plug housing engaging portion 120 includes a first outer surface 120a and a second outer surface 120b. The first and second outer surfaces 120a, 120b define engaging slots 122 (another engaging slot 122 is present, but not shown, on the opposite side of the engaging portion 120). The plug housing engaging portion 120 further includes protrusions 124 (another protrusion 124 is present, but not shown, on the opposite side of the engaging portion 120).

As further shown in FIG. 2, the receptacle connector 106 includes a receptacle housing 126 including a receptacle housing engaging portion 128 and a rear portion 129. The receptacle housing engaging portion 128 includes an insertion portion 130 and engaging features 132. The insertion portion 130 has the at least one receptable contact 117 disposed therewithin configured to mate with a corresponding plug contact (not shown) disposed within the plug connector 104.

The engaging features 132 include fingers 134 and finger grips 136. The fingers 134 include engaging surfaces 135 configured to releasably engage protrusions 124 of the plug connector 104 when the plug connector 104 and receptacle connector 106 are mated. The engaging features 132 are configured such that when the finger grips 136 are sufficiently depressed, the engaging surfaces 135 are released from the protrusions 124 thereby allowing the plug connector 104 and receptacle connector to be unmated. The engaging features 132 are also configured to be received in engaging slots 122 to prevent the plug connector 104 and receptacle connector 106 from axially rotating relative to one another when mated.

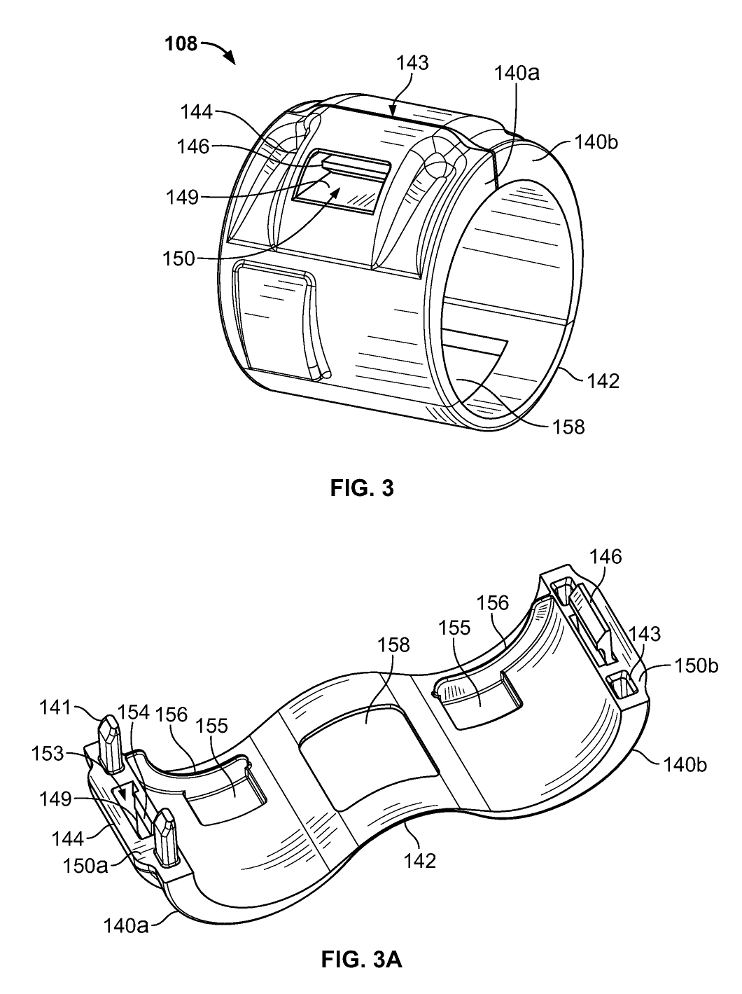

FIGS. 3 and 3A illustrate a more detailed view of the locking clip 108. As shown in FIGS. 3 and 3A, the locking clip 108 includes a first side section 140a, a second side section 140b, and a flexible midsection 142 disposed therebetween. The first side section 140a has a tapered cross section that decreases in thickness from a first side section face surface 150a to flexible midsection 142. The second side section 140b has a tapered cross section that decreases in thickness from a second side section face surface 150b to flexible midsection 142. In another embodiment, the cross sectional thickness of the locking clip 108 may be substantially constant.

The side sections 140a, 140b include a releasable locking feature 133. The releasable locking feature 133 includes a slot housing 144 having a slot 149 included on the first side section 140a. The releasable locking feature 133 further includes a latch 146 included on the second side section 140b. The slot 149 includes a tool opening 150, a tab opening 153, and a retaining surface 154. The latch 146 is configured to be received and releasably engaged within the slot 149 by a retaining surface 154.

The locking clip 108 further includes beams 141 located on the first side section 140a. The beams 141 are configured to be received in beam slots 143 located on the second side section 140b. When the locking clip 108 is closed as shown in FIG. 3, the beams 141 and beam slots 143 prevent stress on latch 146 when clip 108 is subjected to external forces such as impact. The beams 141 received in beam slots 143 also prevents locking clip 108 from substantially twisting. In another embodiment, the beams 141 may be located on the second side section 140b, and beam slots 143 may be correspondingly located on the first side section 140a. In yet another embodiment, beams 141 may be located on both the first side section 140a and the second side section 140b, and corresponding beam slots 143 may be oppositely positioned.

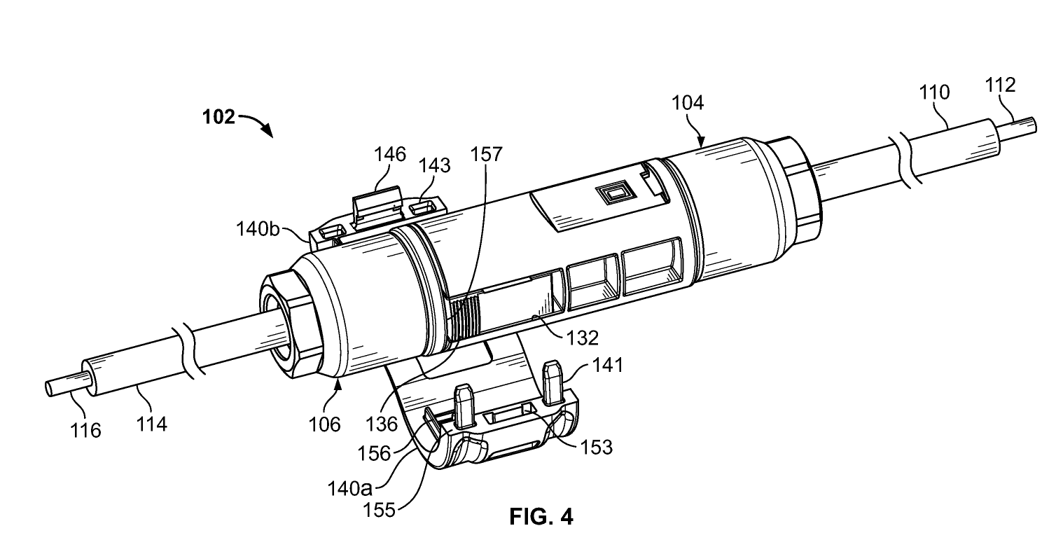

The side sections 140a, 140b further include recesses 155. Recesses 155 are configured to receive and cover the finger grips 136 (FIG. 2) when the electrical connector assembly 102 is assembled as shown in FIG. 1. The side sections 140a, 140b additionally include protrusions 156. The protrusions 156 are configured to be received in a slot 157 (FIG. 4) that is disposed between the engaging features 132 and the rear portion 129 of the receptacle connector 126 (FIG. 2). In another embodiment, the slot 157 may be disposed in the rear housing 129. The protrusions 156, when received in the slot 157, prevent the locking clip 108 from moving axially along the mated plug connector 104 and receptacle connector 106.

The flexible midsection 142 is configured to permit the locking clip 108 to be opened, closed, assembled and unassembled from the mated plug connector 104 and receptacle connector 106. The flexible midsection 142 is formed of a flexible material that permits the locking clip 108 to retain its shape when opened, closed, assembled and unassembled from around the mated plug connector 104 and receptacle connector 106. In this exemplary embodiment, the flexible midsection 142 includes an opening 158. In another embodiment, the opening 158 may be omitted.

FIG. 4 shows a partially assembled electrical connector assembly 102. In FIG. 4, the plug connector 104 and receptacle connector 106 have been mated, and the locking clip 108 is positioned to be assembled around the mated plug connector 104 and receptacle connector 106.

Referring to FIGS. 2 and 4, in one embodiment of assembling the connector assembly 102, the plug connector 104 and receptacle connector 106 are mated by inserting the insertion portion 130 of the receptacle connector 106 into the plug housing engaging portion 120 of the plug connector 104. The engaging features 132 are received in the slots 122 of the plug connector 104 until the retention surfaces 135 engage protrusions 124. The mating of the plug connector 104 and receptacle connector 106 mates the plug contact (not shown) and the receptacle contact 117 to form an electrical connection between the plug conductor 112 and the receptacle conductor 116 as would be appreciated by one of ordinary skill in the art.

Referring to FIG. 4, the locking clip 108 is assembled around the mated plug connector 104 and receptacle connector 106 by positioning the locking clip 108 around the mated plug connector 104 and receptacle connector 106 such that the protrusions 156 are aligned with the slot 157 and the recesses 155 are positioned to cover the finger grips 136. The locking clip 108 is then closed around the mated plug connector and mated connector until the beams 141 are received in beam slots 143 and the latch 146 is received in the latch opening 153 until the latch 146 releasably engages the retaining surface 154 (FIG. 3A) in the latch opening 153.

The locking clip 108 may be opened and unassembled by inserting a tool (not shown) into the tool opening 150 (FIG. 3) and disengaging the latch 146 from the retaining surface 154, and then unassembling the locking clip 108 from around the mated plug connector 104 and receptacle connector 106. The tool may be a standard flat head screw driver or other instrument similarly configured to be inserted into the tool opening 150 and disengage the latch 146.

The receptacle connector 104 may then be released from the plug connector 104 by depressing finger grips 136 to disengage the retaining surfaces 135 of the fingers 132 from the protrusions 124 of the engaging section 120 of the plug connector 104, thereby allowing the plug connector 104 to be unmated from the receptacle connector 106.

Referring to FIGS. 2 and 4, in another embodiment of assembling the connector assembly 102, the locking clip 108 is assembled around the receptacle connector 106 by positioning the locking clip 108 around the receptacle connector 106 such that the protrusions 156 are aligned with the slot 157 and the recesses 155 are positioned to cover the finger grips 136. The locking clip 108 is then closed around the receptacle connector 106 until the beams 141 are received in beam slots 143 and the latch 146 is received in the latch opening 153 until the latch 146 releasably engages the retaining surface 154 (FIG. 3A) in the latch opening 153. The protrusions 156 are received in the slot 157 thereby preventing the locking clip 108 from moving axial on the receptacle connector 106.

The plug connector 104 and receptacle connector 106 are then mated by inserting the insertion portion 130 of the receptacle connector 106 into the plug housing engaging portion 120 of the plug connector 104. The engaging features 132 are received in the slots 122 of the plug connector 104 until the retention surfaces 135 engage protrusions 124. The mating of the plug connector 104 and receptacle connector 106 mates the plug contact (not shown) and the receptacle contact 117 to form an electrical connection between the plug conductor 112 and the receptacle conductor 116 as would be appreciated by one of ordinary skill in the art.

As in the first embodiment of assembling the connector assembly 102, the locking clip 108 may be opened and unassembled by inserting a tool (not shown) into the tool opening 150 (FIG. 3) and disengaging the latch 146 from the retaining surface 154, and then unassembling the locking clip 108 from around the mated plug connector 104 and receptacle connector 106. The tool may be a standard flat head screw driver or other instrument similarly configured to be inserted into the tool opening 150 and disengage the latch 146.

As in the first embodiment of assembling the connector assembly 102, the receptacle connector 106 may then be released from the plug connector 104 by depressing finger grips 136 to disenge the retaining surfaces 135 of the fingers 132 from the protrusions 124 of the engaging section 120 of the plug connector 104, thereby allowing the plug connector 104 to be unmated from the receptacle connector 106.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An electrical connector assembly, comprising:
a plug connector;
a receptacle connector configured to releasably mate with the plug connector; and
a locking clip configured to be assembled and securely closed around the receptacle connector and prevent the plug connector and receptacle connector from being unmated;
wherein the receptacle connector has an engagement feature configured to releasably engage the plug connector; and
wherein the locking clip prevents the engagement feature from being accessed by an operator without the locking clip being first removed by a tool.

2. The electrical connector assembly of claim 1, wherein the locking clip comprises a releasable locking feature comprising a latch and a latch slot configured to securely close the locking clip around the receptacle connector.

3. The electrical connector assembly of claim 2, wherein the releasable locking feature further comprises a tool opening configured to receive a tool to open the locking clip when the locking clip is securely closed.

4. The electrical connector assembly of claim 1, wherein the locking clip comprises a first side section, a second side section, and a flexible midsection disposed therebetween.

5. The electrical connector assembly of claim 4, wherein the first side section comprises a latch slot and the second side section comprises a latch configured to be releasably retained within the latch slot.

6. The electrical connector assembly of claim 5, wherein the first side section further comprises a tool opening configured to provide access to a tool for releasing the latch from the latch slot when the locking clip is securely closed.

7. The electrical connector assembly of claim 4, wherein the first side section includes beams and the second side section includes beam slots configured to receive the beams when the locking clip is securely closed.

8. The electrical connector assembly of claim 4, wherein the flexible midsection comprises an opening.

9. The electrical connector assembly of claim 1, wherein the tool is a standard flat head screw driver.

10. The electrical connector assembly of claim 1, wherein the plug connector cannot be unmated from the receptacle connector while the locking clip is securely closed around the plug connector and receptacle connector when mated.

11. The electrical connector assembly of claim 1, wherein the engagement feature includes a finger grip configured to releasably engage the receptacle connector from the plug connector.

12. The electrical connector assembly of claim 11, wherein the locking clip covers the finger grip to prevent the finger grip from being accessed by an operator and the receptacle connector from being unmated from the plug connector when the locking clip is assembled and securely closed around the mated plug connector and receptacle connector.

13. The electrical connector assembly of claim 1, wherein the locking clip comprises a protrusion and the receptacle connector comprises a slot, and wherein the protrusion and slot are configured to prevent the locking clip from axial movement along the receptacle connector when the locking clip is assembled and securely closes around the receptacle connector.

14. A method of unmating an electrical connector assembly, comprising:
providing an electrical assembly comprising a mated plug connector and receptacle connector and having a locking clip securely closed around the mated plug connector and receptacle connector, wherein the receptacle connector comprises an engagement feature configured to releasably engage the plug connector, and wherein the securely closed locking clip prevents access by an operator to the engagement feature;
opening the locking clip with a tool to provide access to the engagement feature; and
unmating the plug connector and the receptacle connector.

15. The method of claim 14, wherein the locking clip comprises a releasable locking feature comprising a latch slot and a latch that securely closes the locking clip around the mated plug connector and receptacle connector.

16. The method of claim 15, wherein the releasable locking feature further comprises a tool opening for receiving a tool to open the locking clip when closed.

17. The method of claim 14, wherein the locking clip comprises a first side section, a second side section, and a flexible midsection disposed therebetween to permit the locking clip to be securely closed around the mated plug connector and receptacle connector.

18. The method of claim 17, wherein the first side section comprises a latch slot and the second side section comprises a latch configured to be releasably retained within the latch slot when the locking clip is securely closed.

19. The method of claim 18, wherein the first side section further comprises a tool opening that provides access for a tool to release the latch from the latch slot when the locking clip is securely closed.

20. The method of claim 17, wherein the flexible midsection comprises an opening that increases the flexibility of the flexible midsection.

21. The method of claim 14, wherein the tool is a standard flat head screw driver.

22. The method of claim 14, wherein the plug connector cannot be unmated from the receptacle connector when the locking clip is securely closed therearound until the locking clip is opened by the tool.

23. The method of claim 14, wherein the engagement feature includes a finger grip that releasably engages the plug connector when the plug connector and receptacle connector are mated.

24. The method of claim 23, wherein the locking clip covers the finger grip to prevent the receptacle connector from being unmated from the plug connector when the locking clip is securely closed around the mated plug connector and receptacle connector.

25. The method of claim 14, wherein the locking clip comprises a protrusion and the receptacle connector comprises a slot, the protrusion and slot configured to prevent the locking clip from axial movement when the locking clip is securely closed around a mated plug connector and receptacle connector.

26. A locking clip for preventing unmating of a mated plug connector and receptacle connector without the use of a tool, comprising:
a first side section, a second side section, and a flexible midsection disposed therebetween; and
a releasable locking feature configured to securely close the locking clip around the mated plug connector and receptacle connector to prevent the plug connector and receptacle connector from unmating;
wherein the locking clip can only be opened with a tool.

27. The locking clip of claim 26, wherein the releasable locking feature further comprises a tool opening configured to receive a tool to open the locking clip when closed.

28. The locking clip of claim 26, wherein the releasable locking feature comprises a latch slot and a latch configured to be reliable engaged within the latch slot.

29. The locking clip of claim 28, wherein the latch can only be released from the latch slot by a tool.

30. The locking clip of claim 26, further comprising protrusions on the first side section and second side section that prevent the locking clip from moving axial along the receptacle connector when securely closed therearound.

31. The locking clip of claim 26, wherein the first side section includes beams and the second side section includes beam slots configured to receive the beams when the locking clip is securely closed.
